(19) United States
(12) Patent Application Publication
(10) Pub. No.: US 2006/0053034 A1
(43) Pub. Date: Mar. 9, 2006

(54) System and method for providing a real-time status for managing encounters in health care settings

(75) Inventors: Patrick Hlathein, Waunakee, WI (US); Aaron Patterson, Madison, WI (US)

Correspondence Address: GODFREY & KAHN S.C., 780 NORTH WATER STREET, MILWAUKEE, WI, 53202, US

(73) Assignee: Epic Systems Corporation

(21) Appl. No.: 11/033,590

(22) Filed: Jan. 12, 2005

Related U.S. Application Data
(60) Provisional application No. 60/608,341, filed on Sep. 8, 2004.

(51) Int. Cl. G06Q 10/00

(52) U.S. Cl. 705/2

(57) ABSTRACT

A real-time status system for managing encounters in a health care facility is disclosed. The real-time status system includes a graphical user interface in communication with a health care scheduling system for accessing encounters, scheduling information for the encounters, and tracking information for the encounters. The real-time status of the encounters, generated and updated based on the scheduling information for the encounters and the tracking information for the encounters, is displayed on the graphical user interface. A scheduled status of the encounters based on the scheduling information for the encounters can also be displayed on the graphical user interface, and users can selectively view the real-time status and the scheduled status independently or simultaneously.

### BACKGROUND OF THE INVENTION

The present invention relates generally to health care management, and more particularly to a system and method for providing a real-time status for managing encounters in a health care setting.

In a health care setting, it is necessary to effectively and comprehensively manage the progress of encounters, such as surgeries or clinic appointments, from beginning to end. Encounters are usually scheduled, but cannot be managed based on the schedule alone because the encounters rarely proceed according to the schedule due to the many variables involved. For example, a surgical encounter in an operating room could exceed its scheduled time because one of the surgical procedures was more complicated than expected. Conversely, a surgical encounter could be completed earlier than its scheduled time because a scheduled surgical procedure could not be performed or was deemed unnecessary or unadvisable at some point during the surgical encounter. In addition, emergency surgical encounters must be performed before scheduled encounters of lower priority. All of these changes affect the rest of the encounters scheduled in the operating room, rendering the schedule alone an ineffective means for managing encounters. A doctor, for instance, cannot look at the schedule of encounters to accurately determine what time she needs to be ready to perform a surgical procedure on a patient. The encounter may be scheduled at 10am, but for a number of reasons may not actually occur until several hours later. Moreover, in some health care settings, such as the emergency department, encounters are not scheduled at all, requiring another means for managing the encounters that come into the department.

One method currently in use for managing encounters in connection with the schedule is a grease board. Some health care facilities use a grease board or dry erase board that can be manually updated to reflect encounter changes. Additionally, some health care facilities use an electronic version of the grease board that will, in some cases, automatically update based on encounter change and progress information entered into an electronic recordkeeping system. The grease board typically lists each encounter scheduled for a particular facility, such as a surgical department of a hospital, and displays each encounter's current status. For example, a grease board might list each surgical encounter scheduled in each operating room, along with each encounter's status, such as “scheduled,” “arrived,” “in progress” “in pre-op,” etc. The start and end times for each encounter may also be listed. In an emergency department, the grease board is sometimes the only visible record of the status of encounters in each treatment room.

The grease board is a more effective tool for managing encounters than a schedule alone because it does give doctors and other health care practitioners more information regarding the current status of the encounters, instead of merely providing them with the scheduled status of the encounters. When a doctor looks at the grease board, for instance, and sees that the encounter scheduled immediately before her encounter started two hours later than scheduled, she knows that her encounter will be delayed by approximately two hours as well. Grease boards can also be color-coded, assigning a unique color to each status, such as blue for “in progress” encounters or red for “delayed” encounters, to alert users at a glance of the particular status of each encounter.

Although the grease board provides additional information concerning the encounters, it too has significant limitations. For example, the grease board does not display the progress of the encounters in the most logical manner; instead, users must interpret the information presented on the grease board to get an adequate picture of the progress of the encounters. For example, the grease board typically presents information in a tabular format, as opposed to a graphical format. A graphical format would be more intuitive for users, allowing them to quickly view the progress of the encounters without the interpretation required with a tabular format. In addition, most grease boards are not able to calculate estimated start and end times for encounters based on previous encounter progress, or account for the addition of an emergency encounter or an encounter performed out of scheduled order without additional user intervention or interpretation of the data. Further, the grease board does not track the progress of encounters relative to the original schedule for the encounters. A charge nurse in a surgical facility, for instance, cannot look at the grease board alone to determine whether or not the encounters are proceeding as scheduled, or if the encounters need to be rescheduled or moved to other operating rooms.

Given the limitations and problems with the prior art systems and methods described above, there exists a need for an improved system for managing encounters in a health care setting that can provide an accurate real-time status of the encounters in an intuitive graphical format. The present invention relates to improvements over the systems and methods described above, and to solutions to the problems raised or not solved thereby.

### SUMMARY OF THE INVENTION

The present invention provides a real-time status system for managing encounters in a health care setting. The real-time status system includes a graphical user interface in communication with a health care scheduling system for accessing encounters, scheduling information for the encounters, and tracking information for the encounters, and further includes a real-time status of the encounters displayed on the graphical user interface. The present invention provides a graphical representation showing the real-time status of encounters for patients in a health care setting. The real-time status is generated and updated based on the scheduling information for the encounters and the tracking information for the encounters. A scheduled status of the encounters based on the scheduling information for the encounters can also be displayed on the graphical user interface. The real-time status and the scheduled status can preferably be displayed in a graphical format or in a tabular format and are preferably displayed in connection with one another. The present invention compares scheduled encounter information with real-time encounter data to provide a real-time status system for use in viewing and managing the encounters at a glance.

The real-time status system of the present invention calculates a real-time start time and real-time end time for each encounter and displays the real-time status of each encounter based on the real-time start time and the real-time end time for each encounter. The scheduled status of each encounter is displayed based on a scheduled encounter start time and a scheduled encounter end time for each encounter, which are stored in schedules for the encounters. Customizable and configurable visual cues such as icons and color codes are used to indicate characteristics of the displayed encounters. Users can preferably select from the displayed real-time status or scheduled status of one of the encounters and access additional information about the encounter.

The present invention can display a real-time status for encounters in a number of different health care facilities, and for a number of different encounters. For example, the real-time status of encounters in each room of a health care facility, such as surgical encounters in each operating room in a surgical facility, could be displayed, or the real-time status of each health care practitioner in a health care facility, such as clinical encounters for each physician in a clinic, could be displayed. Further, the real-time status system can display the real-time status of encounters that have not been scheduled, and encounters that have been performed out of scheduled order.

The present invention also contemplates a method for managing encounters in a health care setting. The method includes the steps of (1) providing a graphical user interface in communication with a health care scheduling system for accessing encounters, scheduling information for each encounter and tracking information for each encounter, (2) generating a real-time status for each encounter based on the scheduling information for each encounter and the tracking information for each encounter, and (3) displaying the real-time status of the encounters on the graphical user interface. The method can also include the step of updating the real-time status for each encounter, generating a scheduled status for the encounters based on the scheduling information for each encounter, and displaying the scheduled status on the graphical user interface.

The real-time status system of the present invention has several advantages over the prior art systems. For example, the real-time status system provides an intuitive graphical representation of the real-time status of the encounters. Users do not need to interpret information presented in a tabular format. Moreover, users are able to track and view the progress of encounters relative to the schedule for the encounters because the real-time status of encounters can be displayed in connection with the scheduled status of the encounters, allowing users to quickly and easily compare the two statuses. The real-time status system of the present invention is further able to calculate estimated real-time start and end times for encounters, account for encounters performed out of order, and show emergency encounters without additional user intervention.

Various other features, objects, and advantages of the invention will be made apparent to those skilled in the art from the accompanying drawings and detailed description thereof.

### BRIEF DESCRIPTION OF THE DRAWINGS

FIG. 1 is a sample screen shot illustrating an embodiment of the real-time status system of the present invention in a comparison view showing both the scheduled and the real-time status of encounters in several operating rooms;

FIG. 1A is a sample screen shot illustrating an embodiment of the real-time status system of the present invention in a comparison view showing both the scheduled and the real-time status of encounters for several physicians;

FIG. 2 is a sample screen shot illustrating the real-time status system of the present invention in a “real-time only” view showing the real-time status of encounters in the operating rooms of FIG. 1;

FIG. 2A is a sample screen shot illustrating the real-time status system of the present invention in a “real-time only” view showing the real-time status of encounters for the physicians of FIG. 1A;

FIG. 3 is a sample screen shot illustrating the real-time status system of the present invention in a “scheduled only” view showing the scheduled status of encounters in the operating rooms of FIG. 1;

FIG. 3A is a sample screen shot illustrating the real-time status system of the present invention in a “scheduled only” view showing the scheduled status of encounters for the physicians of FIG. 1A;

FIG. 4 is a sample screen shot illustrating the real-time status system of the present invention showing an encounter being performed out of scheduled order;

FIG. 5 is a sample screen shot illustrating the real-time status system of the present invention showing an emergency encounter being performed that was not first scheduled;

FIG. 6 is a sample screen shot illustrating another embodiment of the real-time status system of the present invention showing a grease board view;

FIG. 7 is a sample screen shot illustrating a color configuration screen for selecting the colors displayed in the real-time status system of the present invention;

FIG. 8 is a sample screen shot illustrating an embodiment of an encounter tracking log for inputting information for various encounters of the present invention;

FIG. 9 is a sample screen shot illustrating an embodiment of a configuration screen for configuring the encounter tracking log of the present invention;

FIG. 10 is a flow diagram illustrating an example of logic used to calculate the real-time start time and the real-time end time for a single encounter using the present invention;

FIG. 11 is a flow diagram illustrating an example of logic used to calculate the real-time start time and the real-time end time for all encounters in a single operating room using the present invention; and

FIG. 12 is a graphical representation illustrating an example of an interaction between the real-time status system and the health care scheduling system of the present invention.

### DETAILED DESCRIPTION OF THE INVENTION

The real-time status system of the present invention comprises a graphical user interface capable of displaying a real-time status of encounters in a health care facility. Encounters in a health care facility generally include anytime a health care practitioner has contact with a patient such as but not limited to clinical appointments, office visits, surgical cases, and any procedures, tests, and examinations. The health care practitioner can include all practitioners that work in the health care facility or have any contact with the health care facility or patients in the health care facility, including but not limited to doctors, nurses, physician's assistants, technicians, dieticians, nutritionists, police officers, counselors, pharmacists, nurse practitioners, emergency medical services personnel, and medical students.

The real-time status system of the present invention generates and updates the real-time status, including a real-time start time and a real-time end time, based on scheduling information about the encounters recorded in schedules for the encounters and on actual tracking information about the encounters recorded in tracking logs. Schedules for the encounters include scheduled start times and scheduled end times for the encounters, and can be stored in any form, such as in a database, that is accessible to the real-time status system. Encounter tracking logs record actual start times and actual end times for each encounter, and if appropriate, for each event (panels, procedures, or tracked components thereof including start up or clean up events) within an encounter. The real-time start time and the real-time end time for each encounter correspond either to the actual start time and actual end time recorded in the tracking logs for the encounter, or to estimated start and end times calculated by the real-time status system of the present invention or entered by a user in the tracking log.

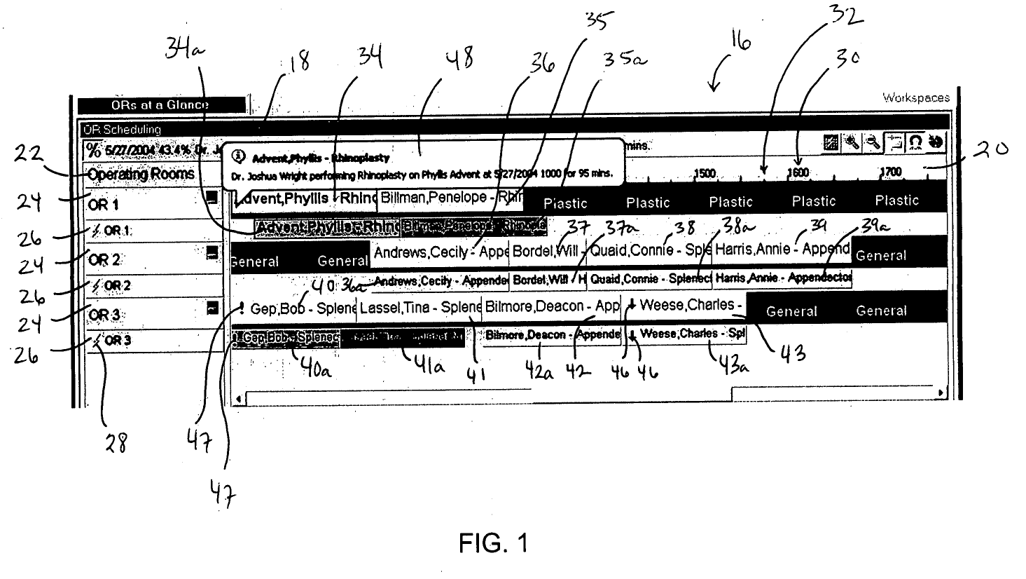

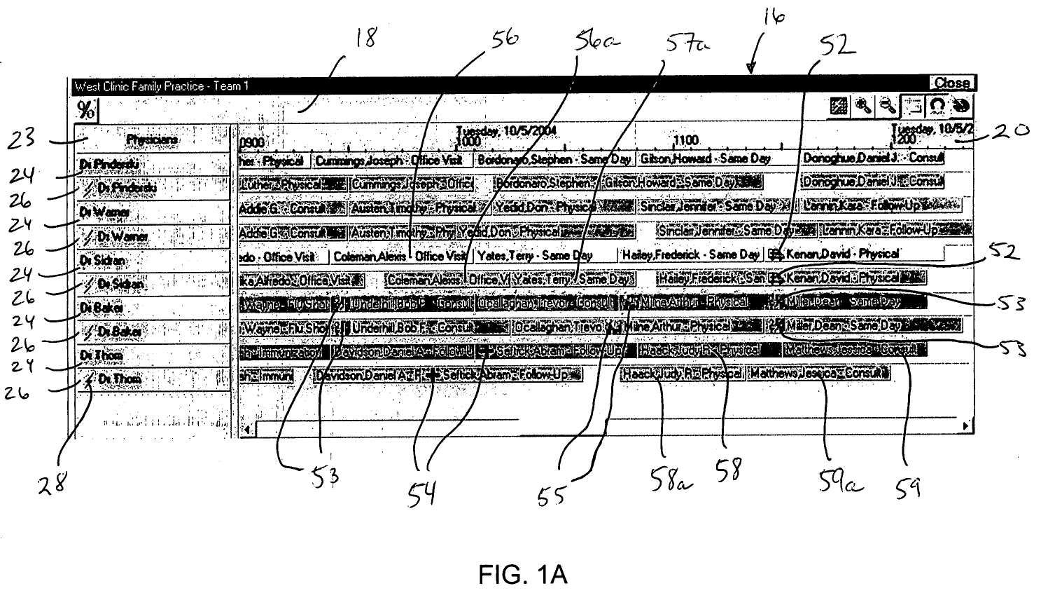

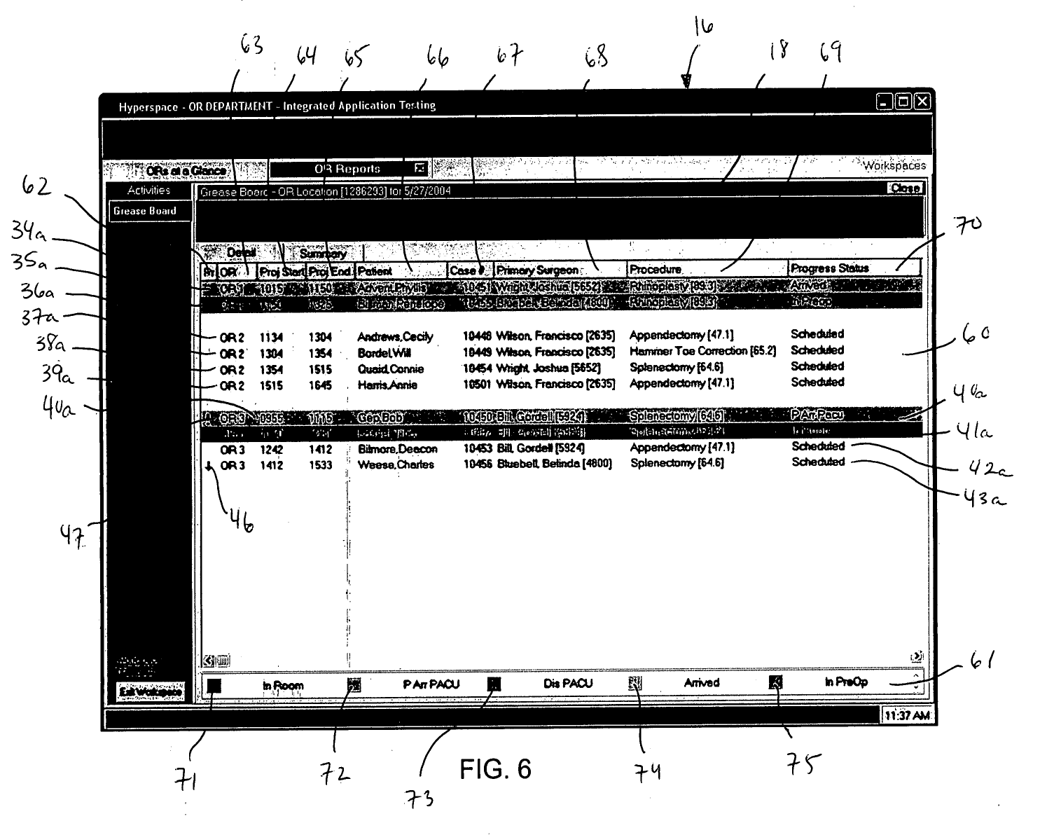

The real-time status can be displayed in a number of formats, including a graphical format such as timelines or bar graphs as shown in FIGS. 1-5, and a tabular format such as a format similar to a traditional grease board as shown in FIG. 6. In addition, the real-time status can be organized in the display by a variety of tracking variables, such as by room as shown in FIGS. 1, 2 and 3 and by physician or other heath care practitioner as shown in FIGS. 1A, 2A and 3A. A room can be defined by the user as a traditional room, such as an operating room, or as any area in which an encounter might take place. For example, in an emergency department, a user may want to track encounters that occur in hallways as well as the waiting room and other areas within the emergency department.

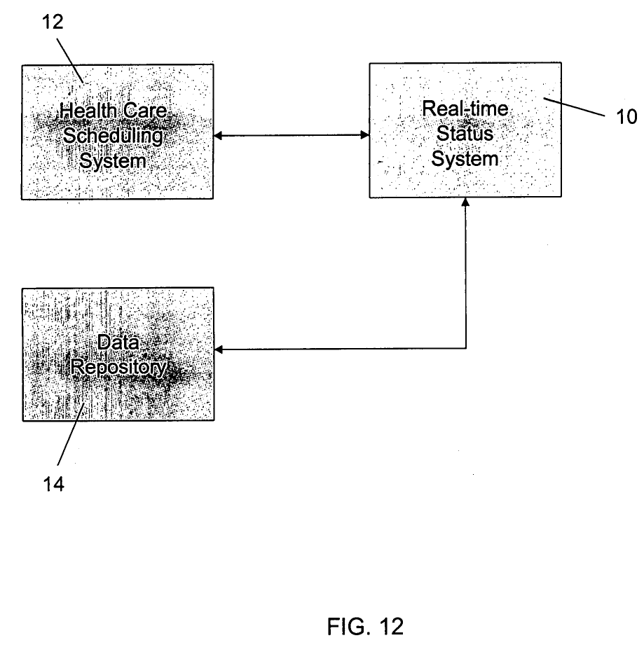

Referring now to the drawings, FIG. 12 shows a graphical representation illustrating an example of an interaction between the real-time status system and the health care scheduling system of the present invention. In FIG. 12, the real-time status system 10 is in communication with a health care scheduling system 12 and a data repository 14. The real-time status system 10 includes a graphical user interface that can communicate with the health care scheduling system 12. The real-time status system 10 of the present invention interacts with the health care scheduling system 12 to access a diverse range of patient data, including health care facility encounters, scheduling information for the encounters, and tracking information for the encounters. All of the patient data could be stored in the health care scheduling system 12, or some of the data could be stored in a separate data repository 14 as shown in FIG. 12. In that case, the real-time status system 10 would be in communication with both the health care scheduling system 12 and the data repository 14 as shown. The health care scheduling system 12 and data repository 14 could be part of a broader health information system, or could be separate systems interfaced together. The specific configuration of the health care scheduling system 12 is not particular to the present invention. However, the health care scheduling system 12 is preferably an integrated application within a health information system having a single data repository 14 capable of manipulating, processing, and sharing data. The health information system could interface with existing health care records management systems to receive information, or the health information system could receive such information through various integrated applications, such as the health care scheduling system 12. The health information system could be configured to support a number of different applications to organize information into a universal patient record. A universal patient record preferably contains all available information referring to or involving a patient, including but not limited to clinical data, appointments and scheduling information, billing and payment status, and insurance and payor information. The health information system could be further configured to manage all aspects of a patient's medical care, including complete clinical, financial, and operational data relating to the patient.

FIG. 1 is a sample screen shot illustrating an embodiment of the real-time status system of the present invention in a comparison view showing both the scheduled and the real-time status of encounters in several operating rooms. FIG. 1 shows the real-time status and scheduled status of encounters in a surgical facility. An encounter in a surgical facility can be a surgical case, procedure, or operation, such as a splenectomy or endoscopy, and the real-time status system can be used to track the real-time status of the surgical encounter from beginning to end. FIG. 1 shows a graphical user interface 16 displaying a window 18 of a health care scheduling system labeled “OR Scheduling.” The window 18 includes a timeline 20 and a column 22 listing the various operating rooms in the surgical facility. Each operating room listed in the column 22 has a first row dedicated to scheduled status 24 and a second row dedicated to real-time status 26. The real-time status rows 26 include a lightning bolt icon 28 to distinguish the real-time status rows 26 from the scheduled status rows 24. Other methods for distinguishing the real-time status from the scheduled status could also be used.

In FIG. 1, the scheduled status for each encounter scheduled to take place in each operating room is displayed in each scheduled status row 24 underneath and corresponding to the timeline 20. The timeline 20 is labeled at each hour 30 of the day and includes tick marks 32 to represent fifteen-minute intervals of time. The scheduled status of each encounter is shown as a bar graph beginning at the scheduled start time for the encounter and ending at the scheduled end time for the encounter. The scheduled status row 24 labeled “OR 1” shows the scheduled status for two encounters scheduled in operating room number 1, the “Advent, Phyllis” encounter 34 and the “Billman, Penelope” encounter 35. The scheduled status row 24 labeled “OR 2” shows the scheduled status of four encounters scheduled in operating room number 2, the “Andrews, Cecily” encounter 36, the “Bordel, Will” encounter 37, the “Quaid, Connie” encounter 38, and the “Harris, Anne” encounter 39. The scheduled status row 24 labeled “OR 3” shows the scheduled status of four encounters scheduled in operating room number 3, the “Gep, Bob” encounter 40, the “Lassel, Tina” encounter 41, the “Bilmore, Deacon” encounter 42, and the “Weese, Charles” encounter 43. The scheduled status of each encounter is shown in yellow to further alert the user that he or she is looking at a scheduled status for the encounter. Each scheduled status row 24 is shown in royal blue for time periods for which no encounters are scheduled.

As also shown in FIG. 1, the real-time status for each encounter taking place or scheduled to take place in each operating room is displayed in each real-time status row 26 immediately below the corresponding scheduled status row 24. Thus, as shown, the real-time status row 26 for operating room number 1, labeled “OR 1” is displayed immediately below the scheduled status row 24 for operating room number 1, labeled “OR 1.” The real-time status row 26 labeled “OR 1” shows the real-time status for the two encounters scheduled in operating room number 1, the “Advent, Phyllis” encounter 34a and the “Billman, Penelope” encounter 35a. The real-time status row 26 labeled “OR 2” shows the real-time status of the four encounters scheduled in operating room number 2, the “Andrews, Cecily” encounter 36a, the “Bordel, Will” encounter 37a, the “Quaid, Connie” encounter 38a, and the “Harris, Anne” encounter 39a. The real-time status row 26 labeled “OR 3” shows the real-time status of the four encounters scheduled in operating room number 3, the “Gep, Bob” encounter 40a, the “Lassel, Tina” encounter 41a, the “Bilmore, Deacon” encounter 42a, and the “Weese, Charles” encounter 43a. Using this comparison view, it is easy for users to compare the scheduled status of the encounters to the real-time status of the encounters. In FIG. 1, for example, a user can compare the real-time status of the “Advent, Phyllis” encounter 34a to the scheduled status of the “Advent, Phyllis” encounter 34 and see that the encounter 34a actually started later than scheduled and is expected to end later than scheduled, which will also delay the next encounter 35a. A user can also compare the real-time status of the “Gep, Bob” encounter 40a with the scheduled status of the “Gep, Bob” encounter 40 to see that the encounter 40a ended earlier than scheduled, which allowed the next encounter 41a to start earlier than scheduled. Thus, users can easily see which encounters are on schedule and which are early or delayed. A charge nurse could effectively use this comparison view to make decisions about scheduling new encounters and the need to reschedule existing encounters.

FIG. 1 also shows the use of various visual cues with the real-time status system of the present invention. For example, color codes are used as visual cues. The real-time statuses of the encounters in FIG. 1 are shown in multiple color codes that correspond to specific characteristics of the status of the encounters. The “Advent, Phyllis” encounter 34a is shown in light pink to indicate that the patient, Phyllis Advent, has arrived in the operating room, the “Billman, Penelope” encounter 35a is shown in dark pink to indicate that the patient, Penelope Billman, is currently in the pre-op area, the “Gep, Bob” encounter 40a is shown in green to indicate that the patient, Bob Gep, has been discharged from the post-anesthesia care unit (PACU), and the “Lassel, Tina” encounter 41a is shown in purple to indicate that the patient, Tina Lassel, is in the operating room undergoing a surgical procedure. Other visual cues are also used, including icons. A down arrow icon 46 is used to indicate that an encounter is a low priority encounter, and an exclamation point icon 47 is used to indicate that an encounter is a high priority encounter. Any icon, color code, or other visual cue can be used to represent any number of different characteristics associated with the encounters, and the real-time status system of the present invention allows users to completely configure and customize the visual cues.

FIG. 1 further shows that a user can select an encounter and view or access additional information about the encounter. In FIG. 1, a user has selected the “Advent, Phyllis” encounter 34 and an information summary box 48 or “tool tip” has appeared providing additional information about the encounter. Users may select encounters in a number of ways, including but not limited to right clicking, double clicking, and hovering over the encounter on the status bar graph. Other methods of interacting with the present invention could also be used, such as but not limited to the use of a touch screen, speech recognition or guidance and portable/tablet/handheld computers. The information summary box 48 preferably displays information pertaining to the encounter, such as but not limited to the type of encounter, the doctor's name, the patient's name, the date, the start time of the encounter, and the length of time the encounter has been ongoing. In FIG. 1, the information summary box 48 shows that Dr. Joshua Wright is performing a rhinoplasty procedure on patient Phyllis Advent on May. 27, 2004 that started at 10 am and has been ongoing for 95 minutes. Users can also preferably select an encounter and access additional information pertaining to the encounter, to the patient, or to the doctor performing the encounter. For example, a user could select an encounter and access information about the patient's insurance, billing history, health history, and medication prescriptions. All information contained in the health information system or health care scheduling system can preferably be accessed by selecting an encounter and requesting the information. A request for information could produce a completely configurable report showing the requested information. For example, a user could choose to display the information without private patient information on a large screen visible to everyone in the health care facility.

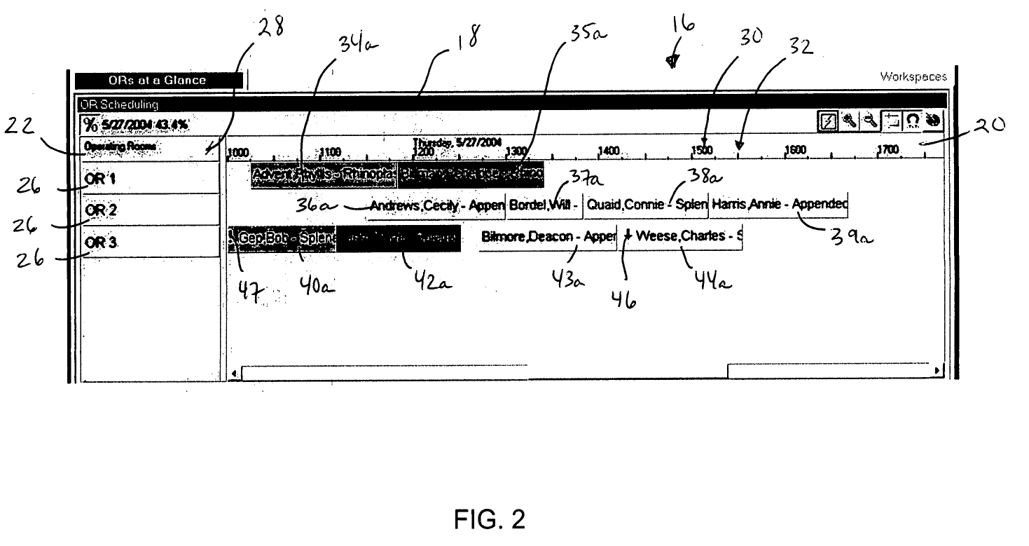

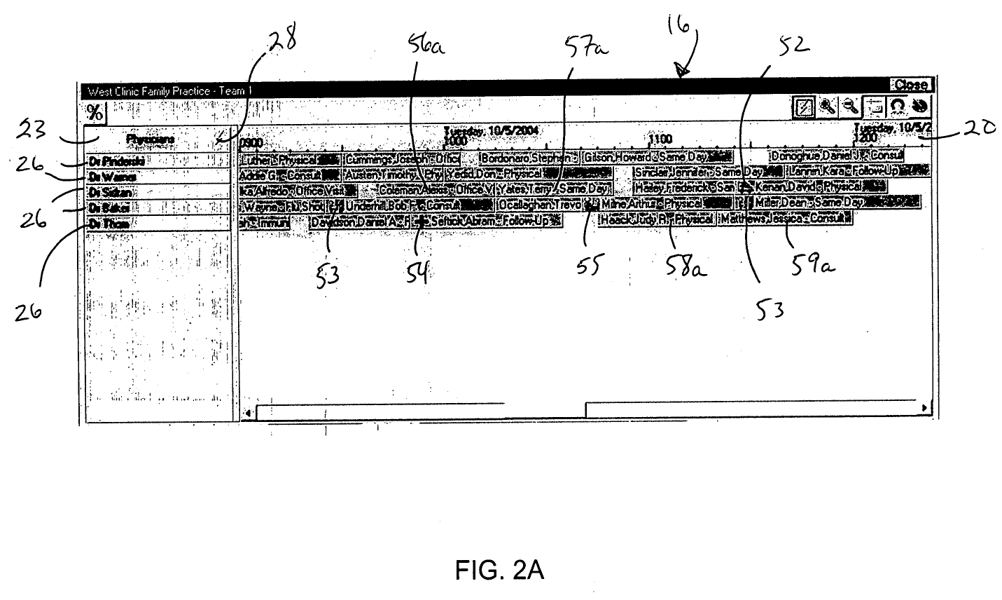

FIG. 2 is a sample screen shot illustrating the real-time status system of the present invention in a “real-time only” view showing the real-time status of encounters in the operating rooms of FIG. 1. FIG. 2 shows only the real-time status rows 26 for each of the operating rooms shown in FIG. 1. The lightning bolt 28 is displayed in connection with the heading in column 22 to indicate that all of the rows in the column 22 are real-time status rows 26 showing the real-time status of the encounters in each operating room. Using the “real-time only” view, users can easily see the real-time status of the encounters. This view is valuable because the real-time status is the only status that is important to some users. For example, a doctor may know that she is scheduled to perform a procedure at 4 pm in operating room number 1, and use the real-time only view to see that the encounter now has a real-time start time of 6 pm. The doctor would then know that she does not need to be ready for another two hours.

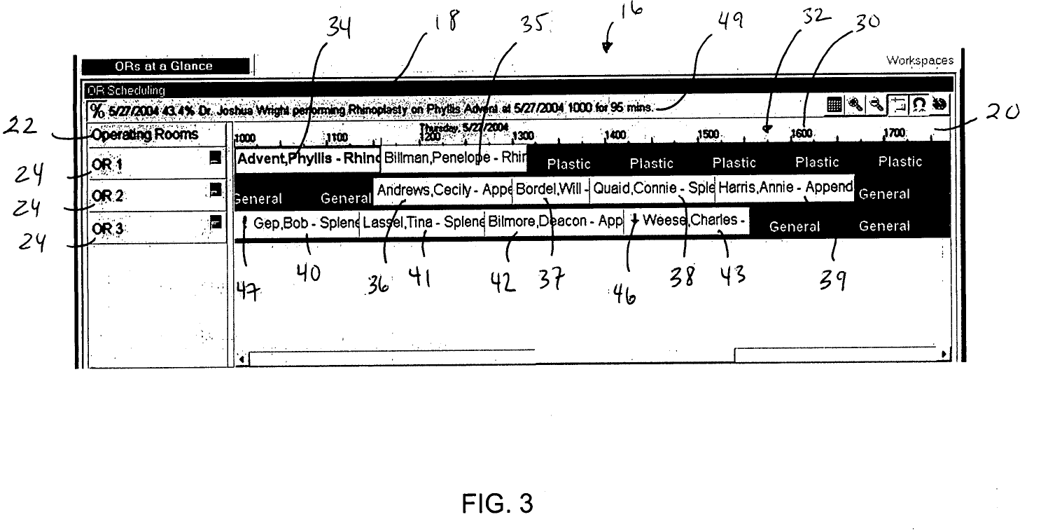

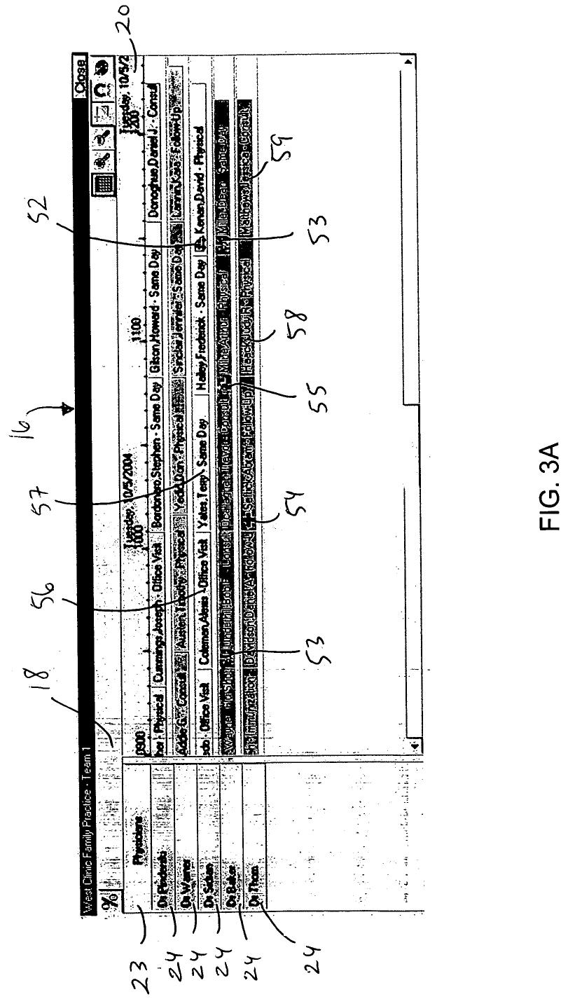

FIG. 3 is a sample screen shot illustrating the real-time status system of the present invention in a “scheduled only” view showing the scheduled status of encounters in the operating rooms of FIG. 1. FIG. 3 shows only the scheduled status rows 24 for each of the operating rooms of FIG. 1. In addition, FIG. 3 shows an informational line of text 49 that appeared when a user selected the “Advent, Phyllis” encounter 34. The option for this “scheduled only” view, while it does not provide real-time status information to the user, is not necessary but is preferred because it provides users with a complete set of viewing options. In addition, although the preferred embodiment includes three views, all three views would not be required to facilitate the present invention, and additional views including other relevant information could also be included. For example, a tabular format view such as a grease board view could also be included. Other views, such as a single room view or single physician view would also be possible. In such views, it would be possible to provide additional levels of detail regarding each encounter associated therewith.

FIG. 1A is a sample screen shot illustrating an embodiment of the real-time status system of the present invention in a comparison view showing both the scheduled and the real-time status of encounters for several physicians. FIG. 1A is analogous to FIG. 1, but shows the real-time status and scheduled status of encounters for physicians in a clinic instead of encounters in a surgical facility. An encounter in a clinic facility could be a patient office visit as shown in FIG. 1A, thus, the real-time status system can be used to show and track the statuses of all patient office visits in the clinic facility from beginning to end. FIG. 1A shows a graphical user interface 16 displaying a window 18 of a health care scheduling system. The window 18 includes a timeline 20 and a column 23 listing the various physicians in a health care clinic. Each physician listed in the column 23 has a first row dedicated to scheduled status 24 and a second row dedicated to real-time status 26. The real-times status rows 26 include a lightning bolt icon 28 to distinguish the real-time status rows 26 from the scheduled status rows 24. As previously noted, other methods for distinguishing the real-time status from the scheduled status could also be used.

The scheduled status for each encounter scheduled for each physician is displayed in each scheduled status row 24 underneath and corresponding to the timeline 20. The timeline 20 is labeled at each hour 30 of the day and includes tick marks 32 for every 15 minutes. The scheduled status of each encounter is shown as a bar graph beginning at the scheduled start time for the encounter and ending at the scheduled end time for the encounter. The scheduled status row 24 labeled “Dr. Pinderski” shows the scheduled status for several encounters scheduled for Dr. Pinderski. Likewise, the scheduled status row 24 labeled “Dr. Warner” shows the scheduled status of several encounters for Dr. Warner, the scheduled status row 24 labeled “Dr. Sidran” shows the scheduled status of several encounters for Dr. Sidran, the scheduled status row 24 labeled “Dr. Baker” shows the scheduled status of several encounters for Dr. Baker, and the scheduled status row 24 labeled “Dr. Thom” shows the scheduled status of several encounters for Dr. Thom. The scheduled status of each encounter is displayed in a color code unique to the physician responsible for the encounter. The scheduled status of Dr. Pinderski's encounters are displayed in beige, the scheduled status of Dr. Warner's encounters are displayed in pink, the scheduled status of Dr. Sidran's encounters are displayed in light yellow, the scheduled status of Dr. Baker's encounters are displayed in teal, and the scheduled status of Dr. Thom's encounters are displayed in blue. As previously described, the color codes used in connection with the present invention can be completely customized and configured by the system administrator or user.

FIG. 1A also shows the real-time status for each encounter displayed in each real-time status row 26 immediately below the corresponding scheduled status row 24. Thus, as shown, the real-time status row 26 for “Dr. Pinderski” is displayed immediately below the scheduled status row 24 for “Dr. Pinderski.” All of the real-time statuses are shown in green to alert the user that the status is a real-time status. Like the comparison view of FIG. 1, the comparison view of FIG. 1A allows users to easily compare the scheduled status of the encounters to the real-time status of the encounters. For example, a user can compare the real-time status of the “Coleman, Alexis” encounter 56a to the scheduled status of the “Coleman, Alexis” encounter 56 and see that the encounter 56a actually started later than scheduled and is expected to end later than scheduled, which will also delay the “Yates, Terry” encounter 57a. A user can also compare the real-time status of the “Haack, Judy” encounter 58a with the scheduled status of the “Haack, Judy” encounter 58 to see that the encounter 58a started earlier than scheduled, which allowed the next encounter, the “Matthews, Jessica” encounter 59a, to start earlier than scheduled. As previously noted, users can easily see which encounters are on schedule and which are early or delayed using this comparison view.

FIG. 1A also shows the use of various visual cues with the real-time status system of the present invention. In addition to the color codes described above, FIG. 1A also shows icons used as visual cues. An ambulance icon 52 is used to indicate an emergency encounter, an open door icon 53 is used to indicate the patient is ready to be discharged, a cross icon 54 is used to indicate the patient is waiting to be seen, and a doctor and nurse icon 55 is used to indicate that the patient is currently being treated. Any icon, color code, or other visual cue can be used to represent any number of different characteristics associated with the encounters, and the real-time status system of the present invention allows users to completely configure and customize the visual cues.

FIG. 2A is a sample screen shot illustrating the real-time status system of the present invention in a “real-time only” view showing the real-time status of encounters for the physicians of FIG. 1A. FIG. 2A is analogous to FIG. 2, and shows only the real-time status rows 26 for each of the physicians shown in FIG. 1A.

FIG. 3A is a sample screen shot illustrating the real-time status system of the present invention in a “scheduled only” view showing the scheduled status of encounters for the physicians of FIG. 1A. FIG. 3A is analogous to FIG. 3, and shows only the scheduled status rows 24 of the physicians shown in FIG. 1A.

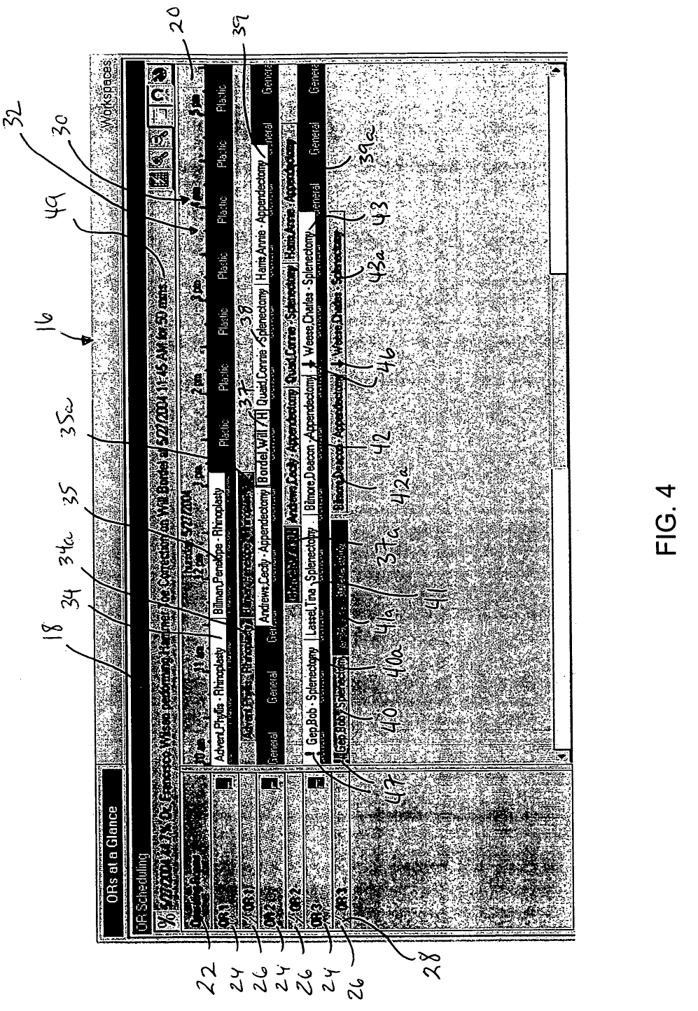

FIG. 4 is a sample screen shot illustrating the real-time status system of the present invention showing an encounter being performed out of scheduled order. FIG. 4 shows the comparison view of FIG. 1, but further illustrates that the comparison view can be used to easily show a user that an encounter is being performed out of scheduled order. In FIG. 4, the scheduled status of the “Bordel, Will” encounter 37 shows that the encounter 37 was scheduled to be performed after the “Andrews, Cecily” encounter 36. The real-time status of the “Bordel, Will” encounter 37a, however, shows that the encounter 37a was actually performed before the “Andrews, Cecily” encounter 36a. FIG. 4 also shows different text in the line of informational text 49, because the user has selected a different encounter, namely, the “Bordel, Will” encounter 37.

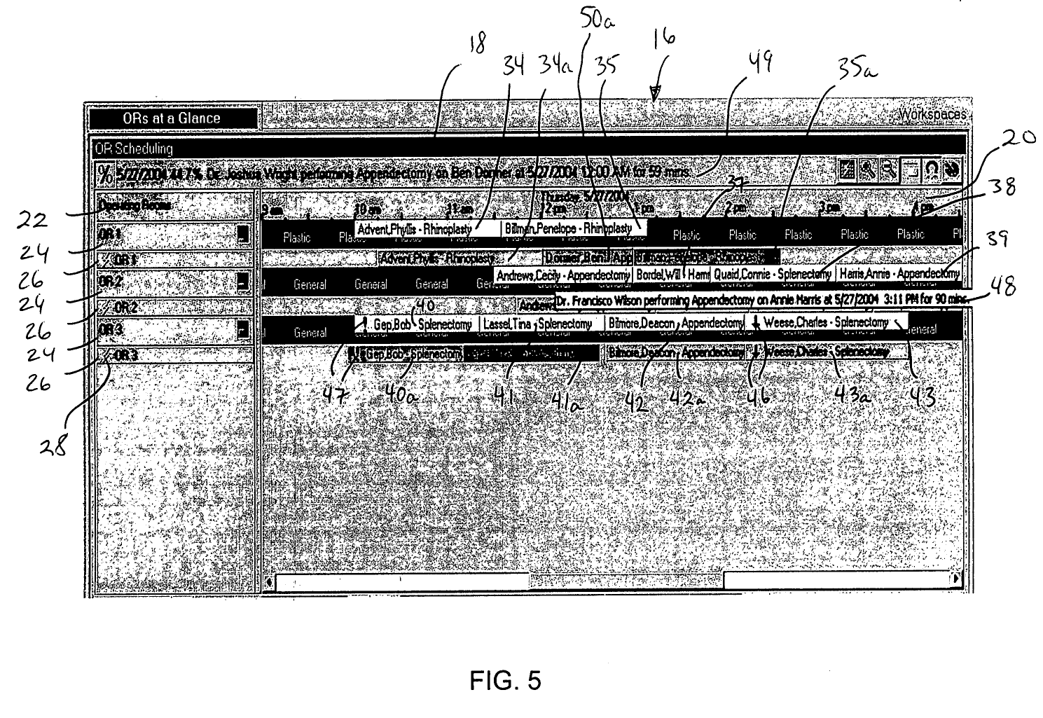

FIG. 5 is a sample screen shot illustrating the real-time status system of the present invention showing an emergency encounter being performed that was not first scheduled. FIG. 5 also shows the comparison view of FIG. 1, but further illustrates that the comparison view can be used to easily show a user that an unscheduled encounter is being performed. Unscheduled encounters are typically emergency encounters that were unable to be first scheduled in the health care scheduling system. FIG. 5 shows the unscheduled “Dormer, Ben” encounter 50a being performed between the “Advent, Phyllis” encounter 34a and the “Billman, Penelope” encounter 35a. FIG. 5 also shows an informational line of text 49 that appeared when a user selected the “Dormer, Ben” encounter 50a, and a tool tip 48 that appeared when a user hovered over the “Harris, Anne” encounter 39.

FIG. 6 is a sample screen shot illustrating another embodiment of the real-time status system of the present invention showing a grease board view. The grease board view can provide the real-time status for encounters in a tabular format. In other words, the grease board view can display the information calculated using the same logic as is used to display information in a graphical format. FIG. 6 shows a graphical user interface 16 displaying a window 18 of a health care scheduling system 12. The window 18 includes a table 60 showing columns of information regarding the encounters in the operating rooms of FIG. 1. The table 60 includes columns for encounter priority 62, operating room 63, projected (or real-time) start time 64, projected (or real-time) end time 65, patient name 66, surgical case number 67, primary surgeon name 68, procedure name 69, and progress status 70. The table 60 also includes a row for each encounter in the health care facility. In FIG. 6, the real-time status is shown for each of the encounters of FIG. 1. Thus, there is a row for the “Advent, Phyllis” encounter 34a, a row for the “Billman, Penelope” encounter 35a, a row for the “Andrews, Cecily” encounter 36a, a row for the “Bordel, Will” encounter 37a, a row for the “Quaid, Connie” encounter 38a, a row for the “Harris, Anne” encounter 39a, a row for the “Gep, Bob” encounter 40a, a row for the “Lassel, Tina” encounter 41a, a row for the “Bilmore, Deacon” encounter 42a, and a row for the “Weese, Charles” encounter 43a The projected start time column 64 displays the real-time start time for each encounter, and the projected end time column 65 displays the real-time end time for each encounter. For example, the real-time start time for the “Advent, Phyllis” encounter 34a is 10:15, and the real-time end time for that encounter 34a is 11:50.

The grease board view shown in FIG. 6 uses the same color codes and icons as the comparison view in FIG. 1. The grease board view in FIG. 6 includes a legend 61. The legend 61 shows the color purple 71 to indicate a patient is in the operating room undergoing a surgical procedure, the color light green 72 to indicate a patient has arrived at the PACU, the color green 73 to indicate a patient has been discharged from the PACU, the color light pink 74 to indicate a patient has arrived in the operating room, and the color dark pink 75 to indicate a patient is in the pre-op area. The down arrow icon 46 and the exclamation point icon 47 are also used, and displayed in the priority column 62. Although the grease board view shown in FIG. 6 corresponds to the graphical format views of FIGS. 1, 2 and 3, the present invention could include only a grease board view for displaying the real-time status of encounters.

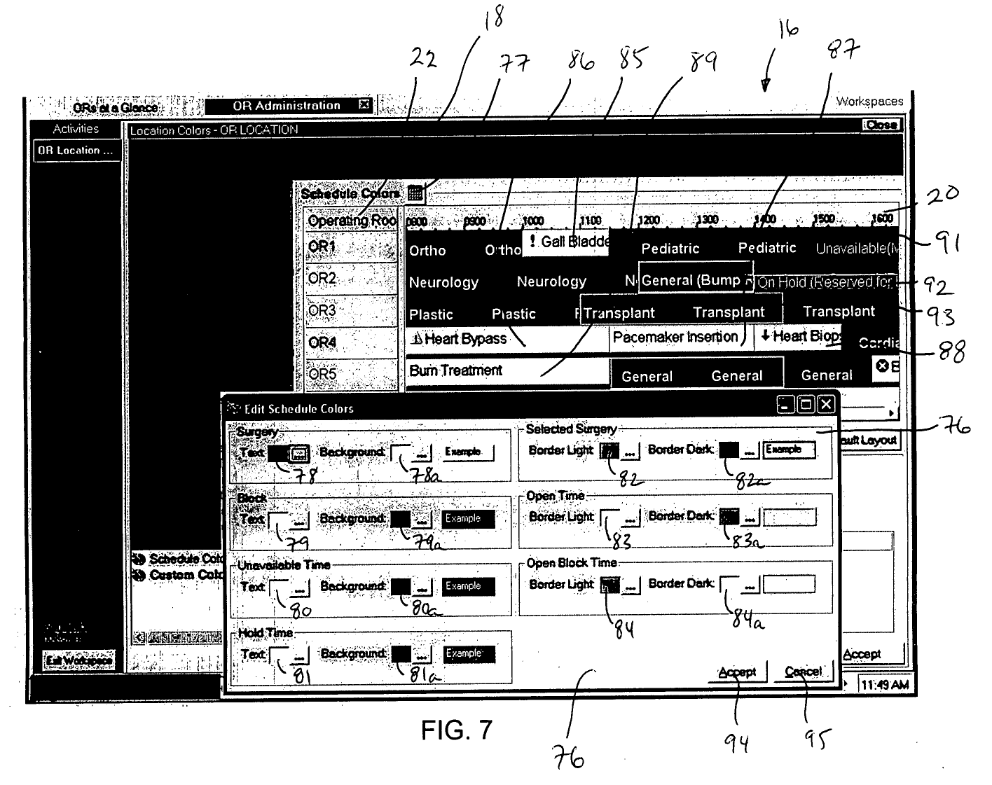

FIG. 7 is a sample screen shot illustrating a color configuration screen for selecting the colors displayed in the real-time status system of the present invention. FIG. 7 shows a graphical user interface 16 displaying a window 18 of a health care scheduling system. The window 18 includes a timeline 20 and a column 22 listing various operating rooms. The scheduled status of each of the encounters is displayed for each operating room. An edit window 76 appeared when a user selected the “schedule colors” button 77 on the window 18. The edit window 76 includes selection boxes for the colors that will be displayed for the text and background of various types of information displayed in the window 18. FIG. 7 shows selection boxes for the text and background for surgeries 78, 78a, blocks of available time 79, 79a, unavailable time 80, 80a and hold time 81, 81a displayed on the window 18. In addition, the edit window 76 includes selection boxes for the color of a border shown around selected information displayed in the window 18. FIG. 7 shows selection boxes for the light and dark border colors around selected surgeries 82, 82a, selected open times 83, 83a, and selected open blocks of time 84, 84a. The colors selected in the edit window 76 are reflected in the display shown in the window 18 of FIG. 7. The gall bladder 85, the heart bypass 86, the pacemaker insertion 87, the heart biopsy 88, and the burn treatment 89 surgeries are shown with a yellow background and black text, blocks of available time 90 are shown in a teal background with white text, unavailable time 91 is shown in a red background with white text, on hold time slots 92 are shown in a gray background with white text, and the selected open block of time 93 is shown with a green and yellow border. The colors are completely configurable and customizable. Once a user has selected the desired colors, the user can select the “Accept” button 94 to accept the color choices, or a user can select the “Cancel” button 95 to cancel the color choices. FIG. 7 shows the edit screen for the colors associated with the scheduled status of the encounters, but the present invention allows a user or system administrator to choose the colors associated with the real-time status of the encounters, as well as the general display colors. Users could choose those colors in an analogous fashion.

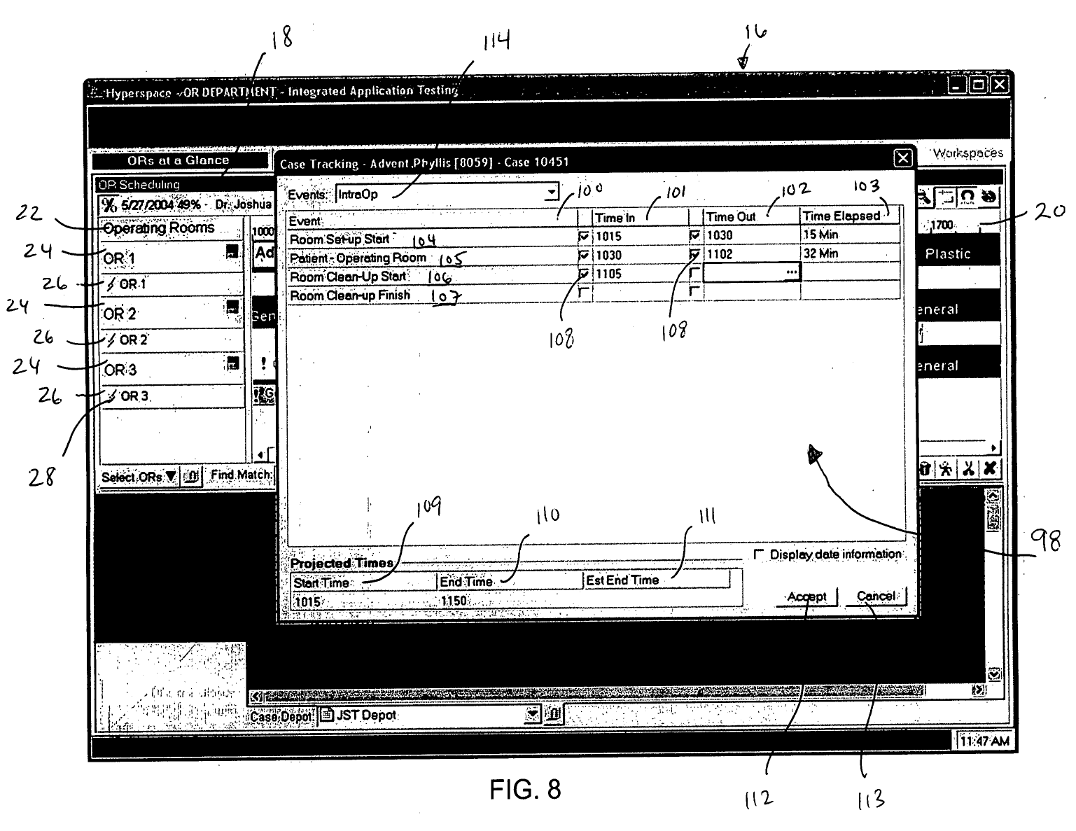

FIG. 8 is a sample screen shot illustrating an embodiment of an encounter tracking log for inputting information for various encounters of the present invention. FIG. 8 shows a graphical user interface 16 displaying a window 18 of a health care scheduling system. The window 18 shows a timeline 20 and a column 22 of various operating rooms. The column 22 includes a scheduled status row 24 and a real-time status row 26 for each of the listed operating rooms. FIG. 8 also shows a tracking window 96 that appeared when a user requested access to the tracking log displayed in the tracking window 96 for a particular encounter. Users can request access to the tracking log in any number of ways, including but not limited to selecting an encounter from the window 18. The tracking log includes a table 98 having a column for the name 100 of the event, the “Time In” 101 (the time the event actually started), the “Time Out” 102 (the time the event actually ended), and the “Time Elapsed” 103 (the time elapsed between the event's actual start and end times). FIG. 8 shows rows for “Room Set-up Start” 104, “Patient-Operating Room” 105, “Room Clean-up Start” 106 and “Room Clean-up Finish” 107. In each row a user can enter the time the event actually started in the “Time In” column 101, and the time the event actually ended in the “Time Out” column 102. In the “Room Clean-up Start” row 104 shown in FIG. 8, for example, a user has entered an actual start time of 10:15 and an actual end time of 10:30. Alternatively, the user can simply check the corresponding check box 108 in the “Time In” or “Time Out” columns 101, 102 to indicate that the event has actually started or ended. The present invention can then automatically fill in the actual start or end time with the time corresponding to the time the check box was checked. Other features for allowing users to quickly enter the actual data can also be used, including but not limited to the use of short cuts such as the letter “n” to indicate a time of “now” or the current time. The tracking log of FIG. 8 is configured to allow a user to view particular event types separately. FIG. 8, for instance, shows “IntraOp” events in a drop down window 114 to indicate that IntraOp event types are currently displayed. A user could use the drop down window 114 to choose to view other event types for a particular encounter, such as “PreOp” or “PostOp” events. FIG. 8 also includes a “Projected Times” box for displaying the projected start time 109, the projected end time 110, and the estimated end time 111. Using the tracking log shown in FIG. 8, the user can enter the estimated end time 111, but the real-time status system calculates the projected (or real-time) start and end times 109, 110. Once a user has entered the desired information into the tracking log, the user can select the “Accept” button 112 to accept or input the information, or a user can select the “Cancel” button 113 to cancel the entered information. The tracking log is a tool for collecting actual tracking information including actual start and end times for encounters and events within encounters. The tracking log is completely customizable and configurable by the user or system administrator, and does not need to have the specific configuration shown in FIG. 8.

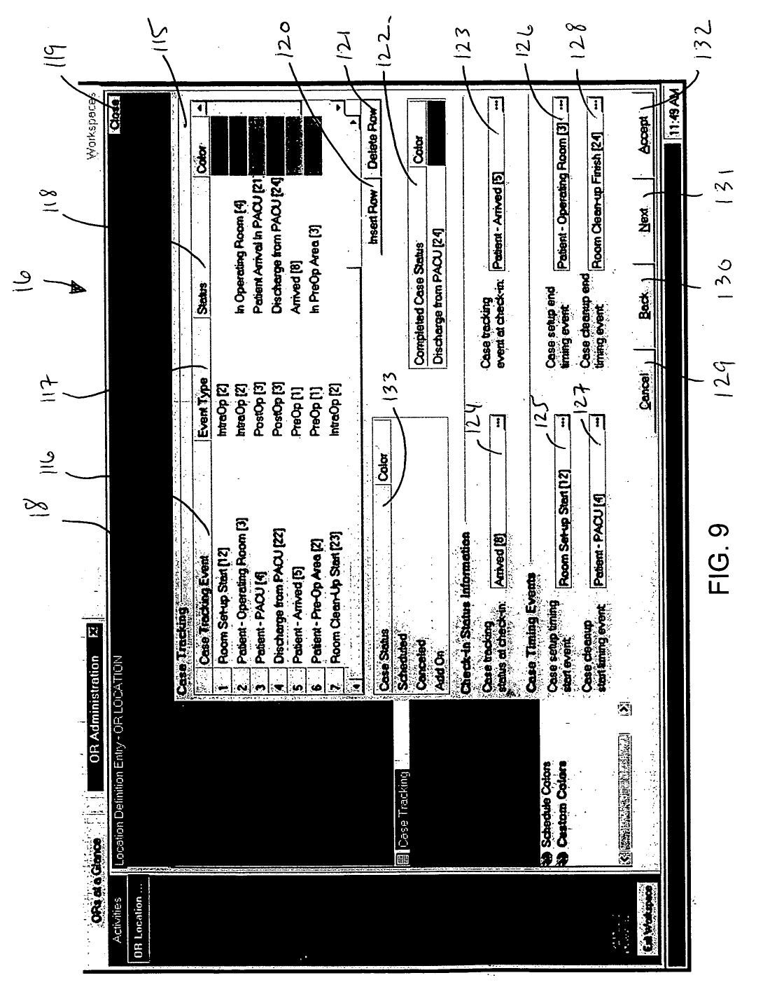

FIG. 9 is a sample screen shot illustrating an embodiment of a configuration screen for configuring the encounter tracking log of the present invention. FIG. 9 shows a graphical user interface 16 displaying a window 18 of a health care scheduling system. A tracking configuration window 15 is also displayed in FIG. 9. The configuration window 115 includes a table with columns for the tracking event name 116, the event type 117, the status 118 associated with the event, and the color 119 associated with the event. The rows of the table contain a list of events that will be used to track a particular encounter. The user can add events to the list by selecting the “Insert Row” button 120, or delete events from the list by selecting the “Delete Row” button 121. The user can also choose which event will signal that the encounter is complete by entering that event into the “Completed Case Status” box 122. For example, the “Completed Case Status” box 122 in FIG. 9 shows that a user has selected the event named “Discharge from PACU” to signal that the encounter is complete. Thus, the actual end time for the encounter will be the actual end time for the “Discharge from PACU” event within the encounter. The user can also choose the status to associate with a patient at check-in by entering that status in the “status at check-in” box 124, and the event to associate with a patient at check-in by entering that status in the “event at check-in” box 123. The user can further choose which colors are associated with particular encounter statuses by entering those colors into the “Case Status” box 133. FIG. 9 also allows a user to choose timing events for the encounter. The set-up start timing event is shown as “Room Set-up Start” in box 125, the set-up end timing event is shown as “Patient-Operating Room” in box 126, the clean up start timing event is shown as “Patient-PACU” in box 127 and the clean up end timing event is shown as “Room Clean-up Finish” in box 128. Thus, the tracking log will start timing the encounter set up when an actual start time is entered for the “Room Set-up Start” event and will stop timing the encounter set-up when an actual start time is entered in the tracking log for the patient's arrival in the operating room, shown as the “Patient-Operating Room” event. The user can use the “Cancel” button 129 to cancel her entries, the “Back” button 130 to go to the previous configuration screen, the “Next” button 131 to go to the next screen, and the “Accept” button 132 accept or input her entries. A user is able to select or deselect any encounter events, including events not shown in FIG. 9, for tracking purposes. The specific configuration screen shown in FIG. 9 is one way in which the user could choose the tracking events, and other methods are certainly possible.

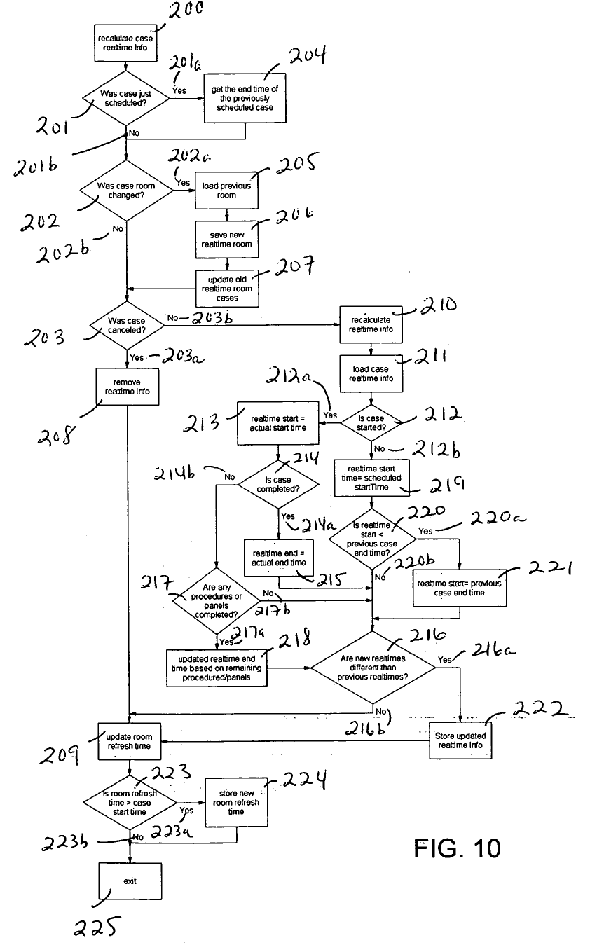

FIG. 10 is a flow diagram illustrating an example of logic used to calculate the real-time start time and the real-time end time for a single encounter using the real-time status system of the present invention. To calculate and update the real-time information, the system of the present invention stores real-time information for each encounter including a real-time start time and a real-time end time. Depending on the status of the encounter, the real-time start time and the real-time end time for the encounter are either actual times as recorded in the encounter tracking log, or estimated times calculated as described below. For instance, if an encounter has started but not yet ended, the real-time start time for the encounter will correspond to the actual start time recorded in the tracking log for the encounter, but the real-time end time will be an estimated end time for the encounter calculated as described below. The real-time start time and the real-time end time for each encounter are displayed on the graphical user interface as the real-time status of the encounter.

To begin recalculating or updating the real-time information for an encounter 200, the real-time status system of the present invention first determines whether the encounter has just been scheduled 201, whether the encounter has had a room change 202, and whether the encounter has been cancelled 203 since the last time the real-time information for the encounter was updated or refreshed. If an encounter B has been scheduled 201a since the last update or refresh, the system retrieves the real-time end time of the previously scheduled encounter A for later use 204. If not 201b, the system moves on to determine whether the encounter room has been changed 202. If the encounter room has been changed from a previous room to a new room 202a, the system saves the new room information 206, loads the real-time information from the previous room 205, and updates the real-time information from the previous room to reflect the room change 207. If the encounter room has not been changed 202b, the system moves on to determine whether the encounter has been cancelled 203. If so 203a, the system removes the real-time information for that encounter from the system 208, and moves on to update the room refresh time 209. If the encounter has not been cancelled 203b, the system recalculates the real-time information for the encounter 210 as described below.

To recalculate the real-time information for an encounter 210, the real-time status system first loads the information stored in the tracking log for the encounter 211. The system then determines whether the encounter has started 212, i.e., if the information from the tracking log contains an actual encounter start time. If so 212a, the real-time start time is then set to the actual encounter start time 213. The system then determines whether the encounter has ended 214, i.e., if the information from the tracking log contains an actual encounter end time. If so 214a, the real-time end time is set to the actual encounter end time 215, and the system moves on to compare the new real-time start and end times with the previously stored real-time start and end times 216. If the encounter has not ended 214b, the system determines whether any events have ended 217, i.e., if the information from the tracking log contains any actual event end times. If so 217a, the system then updates the real-time end time based on the remaining events 218. For example, if there are two events remaining, and those procedures typically take 30 minutes each to complete, the system will update the real-time end time to account for the hour of remaining events. Once the real-time end time is updated 218, the system then moves on to compare the new real-time start and end times with the previously stored real-time start and end times 216. If no events have ended 217b, the system moves on to compare the new real-time start and end times with the previously stored real-time start and end times 216. If an encounter has not started 212b, the real-time start time is then set to the scheduled encounter start time 219, preferably stored in the schedule for the encounter. The system then moves on to compare the new real-time start time for the current encounter B with the real-time end time of the previous encounter A 220. If the real-time end time for the previous encounter A is earlier than the new real-time start time for the current encounter B 220b, the system moves on to compare the new real-time start and end times for the current encounter B with the previously stored real-time start and end times for the current encounter B 216. If the real-time end time for the previous encounter A is later than the new real-time start time for the current encounter B 220a, the real-time start time of the current encounter B is updated and set to the real-time end time of the previous encounter A 221, and the system moves on to compare the new real-time start and end times for the current encounter B with the previously stored real-time start and end times for the current encounter B 216. If the new real-time start and end times are different than the previously stored real-time start and end times 216a, the system updates the real-time information with the new real-time start and end times 222; if the new real-time start and end times are not different than the previously stored real-time start and end times 216b, the system determines that an update is not necessary and moves on to update the room refresh time 209. Once the real-time start and end times have been updated 222, or the system determines that no update is necessary 216b, the system updates the room refresh time to the current time to represent the last time the room was updated 209. The system then compares the updated room refresh time to the new real-time start time for the encounter 223. If the updated room refresh time is later than the new real-time start time for the encounter B 223a, the system will store the updated room refresh time 224, and then the encounter update loop is complete 225. If the updated room refresh time is not later than the new real-time start time for the encounter B 223b, then the encounter update is complete 225.

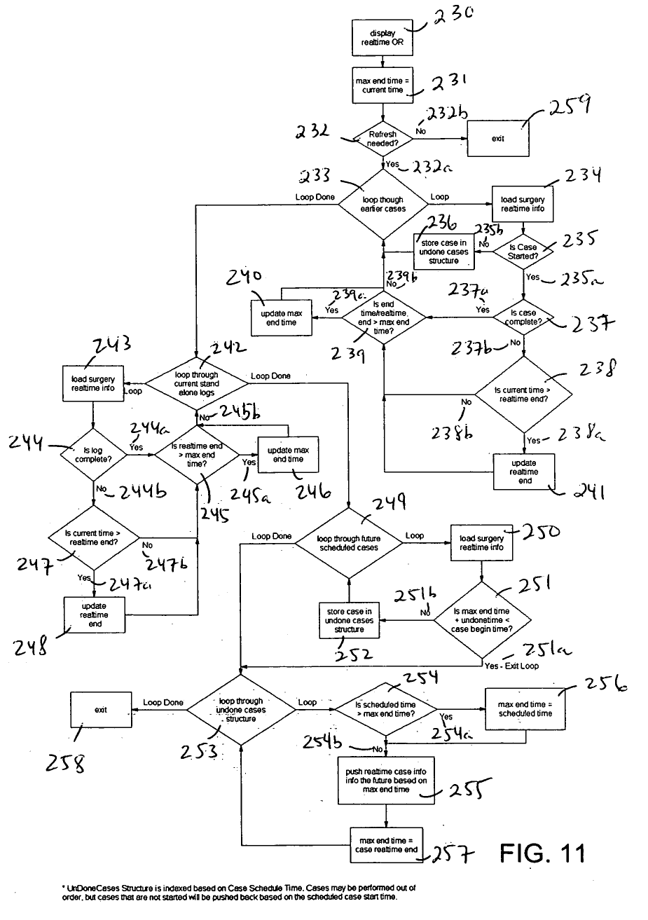

FIG. 11 is a flow diagram illustrating an example of logic used to calculate the real-time start and end times for all encounters in a single operating room using the present invention. In updating the display for an entire room 230, the system stores a maximum end time, which the system initially sets to the current time 231. The system then determines whether a refresh is needed 232. Preferably, the system refreshes when a refresh is requested, but only refreshes the data that is old enough, that is, data that has not been updated in for example the last minute. The system could, however, refresh all the data whenever a request is made, or could refresh all the data automatically at certain time intervals, for example, the system could refresh automatically once every minute. In addition, the system could use logic that includes a modification factor to prevent all of the data for coming up for refresh at the same time, as it is inefficient for the system to refresh all the data at one time. If a refresh is not needed 232b, the update is completed 259. If a refresh is needed 232a, the system then loops through the earlier encounters 233, i.e., the encounters that have real-time start times, calculated as described above and shown in FIG. 10, earlier than the current time. The system downloads the encounter tracking information from the tracking log for each encounter in the room being updated 234, and checks to see if any encounters have started 235. Encounters that have not yet started 235b are stored in an undone encounter structure for later use 236. For encounters that have started 235a, the system then determines whether the encounter has ended 237. If so 237a, the system determines whether the real-time end time for the encounter is later than the maximum end time 239. If not 239b, the system completes the loop for that encounter. If so 239a, the system updates the maximum end time to match the real-time end time for that encounter 240, and completes the loop for that encounter. If an encounter has started but not yet ended 237b, the system determines whether the current time is later than the real-time end time for the encounter 238. If so 238a, the system updates the real-time end time for the encounter to match the current time 241, and then checks to see if the real-time end time is later than the maximum end time 239. If the real-time end time is later than the maximum end time 239a, the system updates the maximum end time 240. If the current time is not later than the real-time end time for the encounter 238b, the system determines whether the real-time end time is later than the maximum end time 239 and if so 239a, updates the maximum end time accordingly 240. The system repeats the loop through the earlier encounters 233 until all of the earlier encounters have been updated.

Once the system has looped through all the earlier encounters 233, the system loops through current stand alone tracking logs 242. Stand alone tracking logs are tracking logs for encounters that were not first scheduled, such as emergency encounters. In some health care settings, it is not necessary to have stand alone tracking logs. For example, in many clinical settings there are rarely emergency encounters, or encounters that are so critical that there would not be enough time to add them to the schedule first. In that encounter, the system would skip the loop through the stand alone tracking logs and loop through future scheduled encounters once the loop through the earlier encounters is complete. The loop through the stand alone tracking logs, as shown, is analogous to the loop through the earlier encounters, with the only difference being that the system does not need to first check to see if the encounter has started because there would not be a stand alone tracking log if the encounter had not yet started. Thus, as shown, the system downloads the encounter tracking information from the stand alone tracking logs in the room being updated 243, and checks to see if any of the encounters have ended 244. If so 244a, the system determines whether the real-time end time for the encounter is later than the maximum end time 245. If not 245b, the system completes the loop for that encounter. If so 245a, the system updates the maximum end time to match the real-time end time for that encounter 246, and completes the loop for that encounter. If an encounter not yet ended 244b, the system determines whether the current time is later than the real-time end time for the encounter 247. If so 247a, the system updates the real-time end time for the encounter to match the current time 248, and then checks to see if the real-time end time is later than the maximum end time 245. If the real-time end time is later than the maximum end time 245a, the system updates the maximum end time 246, and if the real-time end time is not later than the maximum end time 245b, the loop is completed. If the current time is not later than the real-time end time for the encounter 247b, the system determines whether the real-time end time is later than the maximum end time 245 and if so 245a, updates the maximum end time accordingly 246, and if not 245b, the loop is completed. The system repeats the loop through the stand alone tracking logs 242 until all the encounters in the stand alone tracking logs have been updated.

Once the loop through the stand alone tracking logs 242, if required, is complete, the system then loops through the future scheduled encounters 249, i.e., the encounters that have a real-time start time that is later than the current time. The system first loads the tracking log information for the future scheduled encounters for the room being updated 250. The system then determines whether the maximum end time plus the undone time—or the amount of time an encounter was originally scheduled for—is earlier than the real-time start time 251. If not 251b, the encounter is stored in the undone encounters structure 252, and if so 251a, the loop is complete for that encounter. The loop 249 is repeated until all future scheduled encounters for the operating room have been updated.

Once the loop through the future scheduled encounters 249 is complete for all future scheduled encounters, the system loops through the undone encounters in the undone encounter structure 253 for the room being updated. Undone encounters are earlier encounters that have not yet started and future encounters that have a real-time start time that is later than the maximum end time plus the undone time. The system first determines whether the scheduled start time is later than the maximum end time 254 and if not 254b, the system pushes the encounter into the future based on the maximum end time 255. For example, if an encounter was scheduled to start at 4 pm, but the maximum end time is 5 pm, the encounter will be pushed out on the real-time status bar graph, having a real-time start time of 5 pm and a real-time end time one hour later than the previously stored real-time end time. If the scheduled start time is later than the maximum end time 254a, the system updates the maximum end time to match the real-time end time 256 and then pushes the encounter into the future based on the maximum end time 255. On each loop through the undone encounters, the maximum end time is updated to the real-time end time for the undone encounter 257. Once the loop 253 is complete for all undone encounters, the room update is complete 258.

Although example logic for updating the status of rooms and encounters is shown in FIGS. 10 and 11, the logic shown is not particular to the present invention. Other logic could be used, steps could be added or deleted from the logic shown, or the system could use other variables to calculate the real-time status. For example, the real-time status system of the present invention could also calculate the real-time status of a specific room based not only on the status of encounters occurring in that specific room, but also based on the availability of resources or problems that occur in other rooms that may affect the real-time status of the specific room. Thus, if a doctor is scheduled to perform a procedure in Operating Room number 1 at 4 pm, but that doctor is still performing a procedure in a different location that is scheduled to last past 4 pm, the real-time status system could update the real-time status of Operating Room number 1 accordingly. As another example, the system could also include automatic features, such as automatically entering a default actual end time for a previous encounter if the next encounter in that room has been started before an actual end time was entered for the previous encounter. Further, although FIGS. 10 and 11 and the foregoing description refer to encounters tracked by rooms, analogous logic could apply to encounters that are tracked by physician or other tracking criteria. For example, analogous logic would be used to generate the real-time status for each physician in a clinical setting, such as the real-time status shown in FIGS. 1A, 2A, and 3A.

Many other features could be used in connection with the real-time status system of the present invention. For instance, delays shown on the real-time status system could also trigger other actions. As soon as a real-time end time for a particular encounter is later than the scheduled end time, the system could send an email, page or other message to the charge nurse or the reception desk so that the schedules or other resources could be modified accordingly. In addition, real-time information could be used in many other health care scheduling system functions. When a user searches for open times, for example, the real-time information could be used to prevent the user from scheduling a new encounter in what looks like an open time slot on the schedule, but is really not an open time slot because the earlier cases had been delayed. The real-time information could also be used on staffing schedules, to let staff know when encounters for which they are scheduled are actually going to start.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A real-time status system for managing encounters in a health care setting, the status system comprising:
a graphical user interface in communication with a health care scheduling system for accessing encounters, scheduling information for the encounters, and tracking information for the encounters; and
a real-time status of the encounters displayed on the graphical user interface, the real-time status generated and updated based on the scheduling information for the encounters and the tracking information for the encounters.

2. The real-time status system of claim 1, further comprising a scheduled status of the encounters displayed on the graphical user interface, the scheduled status based on the scheduling information for the encounters, the scheduled status displayed in connection with the real-time status.

3. The real-time status system of claim 2, wherein the real-time status is distinguishable from the scheduled status.

4. The real-time status system of claim 1, wherein the real-time status is displayed in a graphical format.

5. The real-time status system of claim 2, wherein the scheduled status is displayed in a graphical format.

6. The real-time status system of claim 1, wherein the real-time status is displayed in a tabular format.

7. The real-time status system of claim 2, wherein the scheduled status is displayed in a tabular format.

8. The real-time status system of claim 1, wherein the real-time status system calculates a real-time start time and a real-time end time for each encounter.

9. The real-time status system of claim 8, wherein the real-time start time and the real-time end time are displayed for each encounter.

10. The real-time status system of claim 2, wherein the scheduled status is displayed based on a scheduled start time and a scheduled end time for each encounter, the scheduled start time and the scheduled end time stored in the scheduling information for the encounters.

11. The real-time status system of claim 1, further comprising a plurality of visual cues to indicate a plurality of characteristics of the encounters.

12. The real-time status system of claim 11, wherein the visual cues are color codes.

13. The real-time status system of claim 11, wherein the visual cues are icons.

14. The real-time status system of claim 11, wherein the visual cues are customizable.

15. The real-time status system of claim 11, wherein the visual cues are configurable.

16. The real-time status system of claim 1, wherein a user can select the displayed real-time status for one of the encounters and access additional information about the encounter.

17. The real-time status system of claim 2, wherein a user can select the displayed scheduled status for one of the encounters and access additional information about the encounter.

18. The real-time status system of claim 1, wherein a user can select the displayed real-time status of one of the encounters and view additional information about the encounter.

19. The real-time status system of claim 2, wherein a user can select the displayed scheduled status of one of the encounters and view additional information about the encounter.

20. The real-time status system of claim 1, wherein the health care scheduling system is an application in a health information system.

21. The real-time status system of claim 1, wherein the real-time status system is periodically updated.

22. The real-time status system of claim 1, wherein the real-time status system is automatically updated.

23. The real-time status system of claim 1, wherein the real-time status of encounters is displayed for each room in a health care facility.

24. The real-time status system of claim 1, wherein the real-time status of encounters is displayed for each health care practitioner in a health care facility.

25. The real-time status system of claim 1, wherein the encounters are surgical encounters.

26. The real-time status system of claim 1, wherein the encounters are clinical encounters.

27. The real-time status system of claim 1, wherein the encounters are emergency department encounters.

28. The real-time status system of claim 1, wherein the real-time status displayed can include a real-time status for encounters that have not been scheduled.

29. The real-time status system of claim 1, wherein the real-time status displayed can include a real-time status for encounters that have been performed out of scheduled order.

30. The real-time status system of claim 1, wherein the real-time status displayed can show whether encounters are being performed according to schedule.

31. A method for managing encounters in a health care setting, the method comprising:
providing a graphical user interface in communication with a health care scheduling system for accessing encounters, scheduling information for each encounter and tracking information for each encounter;
generating a real-time status for each encounter based on the scheduling information for each encounter and the tracking information for each encounter; and
displaying the real-time status of each of the encounters on the graphical user interface.

32. The method of claim 31, further comprising the step of updating the real-time status for each encounter.

33. The method of claim 31, further comprising the steps of generating a scheduled status for the encounters based on the scheduling information for each encounter, and displaying the scheduled status on the graphical user interface.

34. The method of claim 33, wherein the scheduled status is displayed in connection with the real-time status.

35. An encounter management system for a health care facility, the system comprising:
a real-time status of encounters displayed on a graphical user interface, the real-time status of the encounters generated and updated based on scheduling information for the encounters and tracking information for the encounters; and
a scheduled status of the encounters displayed on the graphical user interface, the scheduled status based on the scheduling information for the encounters.

36. The encounter management system of claim 35, wherein users can selectively view the real-time status and the scheduled status independently or simultaneously.
